(19) United States
(12) Patent Application Publication
(10) Pub. No.: US 2007/0224329 A1
(43) Pub. Date: Sep. 27, 2007

(54) Water Contained With Mushroom Constituent And A Producing Method Thereof, And A Water Product Contained With Mushroom Constituent

(76) Inventor: Youn-Jeong Oh, Chungcheongnam-do (KR)

Correspondence Address: IPLA P.A., 3580 WILSHIRE BLVD., 17TH FLOOR, LOS ANGELES, CA, 90010, US

(21) Appl. No.: 10/596,621

(22) PCT Filed: May 16, 2005
(86) PCT No.: PCT/KR05/01423

§ 371 Date: Jun. 19, 2006

(30) Foreign Application Priority Data
May 17, 2004 (KR) 10-2004-0034659

(51) Int. Cl. A23L 2/38

(52) U.S. Cl. 426/590

(57) ABSTRACT

A Phellinus linteus beverage product of the present invention is prepared by the following steps: adding 0.07 0.2 weight parts of Phellinus linteus into 100 weight parts of water; boiling water containing Phellinus linteus for 4 5 hours to obtain Phellinus linteus extract; filtering the Phellinus linteus extract to eliminate sludge of Phellinus linteus; sterilizing the Phellinus linteus extract; and filling the Phellinus linteus extract into heat-resisting containers. The Phellinus linteus beverage of the present invention is drinkable as drinking water owing to similar flavor to barley or corn tea, low-priced, and at the same time has a unique flavor and effects of Phellinus linteus.

### TECHNICAL FIELD

The present invention relates to a mushroom, in particular Phellinus linteus, beverage, a producing method thereof, and a Phellinus linteus beverage product prepared thereby.

### BACKGROUND ART

Phellinus linteus is a perennial mushroom belonging to Basidiomycota growing naturally on old wild mulberry trees which inhabit alpine regions. The mushroom is known to have excellent effects of anticancer, increasing innate immunity, and detoxification. Because of such effects, Phellinus linteus has been either added to Chinese herb medicine for treating a disease or for simply enhancing health condition as a part of composition or used separately, or used for making alcohol.

General method to prepare medicines or health foods using mushrooms is described in Korean Patent Publication No. 1999-29838, No. 2000-1527, No. 2000-37814, and No. 2000-58233. However, in these Publications, mushroom products are provided as a mixed extract of ginseng, jujube, honey, etc with mushroom for the use as a Chinese herb medicine or health food. Thus, according to the above inventions, the original flavor and effects of Phellinus linteus cannot be possessed.

In addition, the mushroom products proposed by the above Publications include high price materials, resulting in high price mushroom products. Further, complicated production procedure is also a problem.

### DISCLOSURE OF INVENTION

### Technical Problem

It is an object of the present invention to provide a Phellinus linteus beverage that is drinkable just like drinking water because it has spring water or barley tea or corn tea like flavor, and is as low-priced as spring water on the market.

It is another object of the present invention to provide a Phellinus linteus beverage that possesses original flavor and effects and has moderate price by producing it with only Phellinus linteus.

It is a further object of the present invention to provide a producing method of the Phellinus linteus beverage.

It is also an object of the present invention to provide a Phellinus linteus beverage product available for marketing and distribution.

### TECHNICAL SOLUTION

To accomplish the above object, the present invention provides a producing method of a Phellinus linteus beverage provided in a preferred embodiment of the present invention (Example 1) which characteristically includes the following steps: adding 0.07-0.2 weight parts of Phellinus linteus into 100 weight parts of water; boiling water containing the Phellinus linteus for a required time; and filtering the Phellinus linteus dissolved in water.

Herein, the step of boiling is composed of two sub-steps, which are the first boiling step in which water is boiled by high temperature heat upto the boiling point, and the second boiling step in which water containing Phellinus linteus is continuously boiled by lower temperature heat from the boiling point. And the boiling time for the second boiling is preferably 4 5 hours.

In the step of filtering, water containing Phellinus linteus is filtered at least three times to eliminate sludge completely from the water to be a drinkable Phellinus linteus beverage.

In another preferred embodiment of the present invention (Example 2), a producing method of a Phellinus linteus beverage characteristically includes the following steps; adding 0.07 0.2 weight parts of Phellinus linteus into 100 weight parts of water; boiling water containing Phellinus linteus for a required time to obtain Phellinus linteus extract; filtering the Phellinus linteus extract; and producing a Phellinus linteus beverage by mixing the Phellinus linteus extract and R/O water at fixed ratio; and sterilizing the beverage by UHT method.

Purified R/O water having 20-30 hardness is preferably used in this invention.

In the boiling step, a process of regular heating and regular circulation is repeated. At this time, regular boiling time is approximately 40 minutes and regular circulation time is approximately 20 minutes.

The Phellinus linteus beverage of the present invention is sterilized by UHT method for long-term storage.

The present invention provides a Phellinus linteus beverage produced by the above method and also a Phellinus linteus beverage product produced by filling the Phellinus linteus beverage into fluid containers.

### ADVANTAGEOUS EFFECTS

According to the present invention, a Phellinus linteus beverage that is drinkable as drinking water owing to similar flavor to barley or corn tea, low-priced, and keeping natural effects, and a producing method of the same are provided.

A Phellinus linteus beverage product which is packed in separate containers, distributed, and sold to consumers for easy drinking is also provided.

In addition to the use as drinking water, the Phellinus linteus beverage of the present invention can also be added, instead of water, to prepare nourishing meals such as Backsuk (chicken meat boiled in plain water) or Komtang (shank bone soup), enhancing the taste and flavor of the meals.

### MODE FOR THE INVENTION

Practical and presently preferred embodiments of the present invention are illustrative as shown in the following Examples.

### Example 1

To produce a Phellinus linteus beverage of the present invention, dehydrated Phellinus linteus is prepared first. To prepare the dry Phellinus linteus, Phellinus linteus is washed to eliminate impurities and then dried by conventional food drying method. The drying method can be either direct drying in the sunlight or drying with air blowing by using a drier.

The obtained dry Phellinus linteus is cut into small pieces. At this time, the size of pieces is preferred to be 1 cm square.

Then, a water pot and a heating device are prepared. The pot is not limited in size, and either a 4 L pot or a bigger pot is good. But, a bigger container that is able to contain over 1,000 L of water is preferred in the present invention for mass-production.

Any kind of water can be used in this invention only if it is fit for drinking water. However, pure water without any food additive is preferred to maintain the original taste and flavor and effects of Phellinus linteus.

A container is filled with water, to which Phellinus linteus is added. The preferable ratio of water to Phellinus linteus is 100 weight parts to 0.07 0.2 weight parts, indicating that 1 liter of water contains 0.7 2 g of Phellinus linteus.

A Phellinus linteus beverage prepared by the above mixing ratio has a similar color and flavor to those of barley tea or corn tea, making people feel like they are drinking a drinking water not a functional beverage. Thus, it is possible to drink a Phellinus linteus beverage without any rejection or discomfort when people are thirsty, having meals or after meals. Such similarity to barley or corn tea gives people an incentive to drink Phellinus linteus beverage more often, contributing to the increase of effects of Phellinus linteus.

When the content of Phellinus linteus in 100 weight parts of water is over 0.2 weight parts, the flavor of Phellinus linteus becomes as dark and strong as a Chinese herb medicine, resulting in unfitness for drinking water and increase of price. In the meantime, when the content of Phellinus linteus in water is less than 0.07 weight parts, it is difficult to get natural effects of Phellinus linteus and to enjoy barley or corn tea like drinking because the beverage has almost no taste and flavor owing to too much low content.

From the experiments of the present invention, it was confirmed that the optimum content of Phellinus linteus in 100 weight parts of water was 0.1 weight parts, meaning that it is more preferred to add Phellinus linteus by 0.1 g to 1 liter of water. With this concentration, Phellinus linteus beverage can provide very similar color and taste to barley or corn tea and full effects as well.

After adding Phellinus linteus into water, it begins to boil. Water is heated at high temperature from the beginning to the boiling point in a short time. Then, the heat temperature is lowered from the boiling point for further boiling. A certain time is required for Phellinus linteus to be infused fully in the boiling water, and lowering temperature is to prevent excessive evaporation of water during the boiling. Thus, starting with high temperature boiling and then lowering heat temperature for further boiling result in successful and efficient infusion of Phellinus linteus and keeping the content of Phellinus linteus unchanged therein. It is possible to add Phellinus linteus into water after water is boiled to some degree to save boiling time during the first boiling at high temperature.

The second boiling at lower temperature is preferably performed for 4 5 hours. When the ratio of water to Phellinus linteus is set as 100 weight parts to 0.1 weight parts, 4 hour boiling is most preferred to provide the best taste and flavor and the optimum content of Phellinus linteus for the best effects.

After Phellinus linteus is completely infused in boiling water, the solution is cooled down. To cool down the solution, the water solution is left at room temperature until it is naturally cooled down or the water solution is cooled down by using a freezer where a coolant is circulated for cooling.

Upon cooling, water containing Phellinus linteus is filtered with the generally used mesh filter. Filtering is performed several times, otherwise minute sludge of Phellinus linteus produced during the boiling might not be filtered completely, so the final Phellinus linteus product can contain those Phellinus linteus sludge. Therefore, it is preferred to filter the water solution more than three times, but it is possible to do filtering just three times for efficiency of the production process.

In the case that filtering is performed three times, 50 □ filter is used for the first filtering, 25 □ filter is used for the second filtering, and 1 □ filter is used for the final filtering. As mentioned before, repeated filtering results in elimination of minute sledges step by step.

A fluid container is filled with Phellinus linteus beverage produced above to prepare final Phellinus linteus beverage product. As a fluid container, a transparent heat-resisting PET container, generally used for beverage containing, is preferably used. The produced Phellinus linteus beverage shows similar color to barley tea, so Phellinus linteus in a transparent container gives consumers familiarity like barley tea, leading them to drink it with ease. If long-term storage is not necessary, a disposable container can be used, but for long-term storage and distribution, air-tight container like can or heat-resisting PET container usable after being sterilized is used.

The final Phellinus linteus beverage product packed in containers is ready to be distributed and sold, so as for consumers to purchase and drink easily.

### Example 2

In this example, a Phellinus linteus beverage is prepared by following steps; measuring raw materials→subdividing raw materials→extracting→filtering→compounding (mixing)→filtering→UHT sterilizing→filling.

In the step of measuring, Phellinus linteus pieces which are in 1 cm square are weighed. In the step of subdividing, the weighed raw materials (Phellinus linteus pieces) are subdivided into 6 8 bags per 1 batch (4,500 L).

Then, subdivided raw materials are extracted. In this step of extracting, the raw materials are put in R/O water (Reverse Osmosis Water), which is not heated yet.

Phellinus linteus is preferably added by 0.07 0.2 weight parts into 100 weight parts of R/O water.

The water containing Phellinus linteus is heated at 98° C.-100° C. Precisely, the water is heated by the repeated procedure of 40 minute heating and 20 minute circulation, and boiling time from reaching 98° C. is 5 hours.

As described in Example 1, general drinking water can be used for the preparation of a Phellinus linteus beverage, but R/O water is more preferred to produce the drink with original flavor and color of Phellinus linteus.

R/O water with the hardness level of 20-30 is preferably used herein. This is determined to be the best hardness range to produce the most drinkable Phellinus linteus beverage through experiments investigating the flavor and color of Phellinus linteus beverages prepared from R/O water with different hardness levels. Hardness herein means the content of minerals (K, Ca, Mg, etc) in R/O water. The standard level of hardness for drinking water is under 300, and in general drinking water is in the hardness range between 60 and 90. In the present invention, R/O water with the hardness of 20-30 is used to enhance color and flavor of the drink.

Upon completion of extracting, filtering is performed three times by using different filters, and then the filtered extract and R/O water are mixed at the ratio of 1:1. The resultant Phellinus linteus beverage is finally filtered with 1 □ mesh filter.

The filtered Phellinus linteus beverage is sterilized by UHT sterilizing process. UHT method means ultra high temperature sterilizing process, and the temperature at this time is approximately 121° C. 130° C., and more preferably 121° C. Heating time is approximately 90 seconds. The temperature is determined to get enough sterilizing effect but not to damage the flavor of a final beverage product. That is, the higher the temperature and the longer the time, the bigger sterilizing effect is obtained. But, the increase and the extension of temperature and time without limitation results in the damage of the flavor of a beverage. For example, rice beverages are sterilized at 128° C. and green tea beverages are sterilized at 133° C. by UHT method. However, these temperatures are not good for sterilization of a Phellinus linteus beverage. Only such beverages having pH 6.5 6.8 can be sterilized at those temperatures.

Taking all the above into consideration, sterilizing temperature and time for a Phellinus linteus beverage were determined. Long-term storage is also possible by UHT method.

If necessary, sterilizing temperature can be lowered than the temperature mentioned above. In that case, sterilizing time needs to be extended. And if necessary, sterilizing temperature can also be increased, and in that case, sterilizing time needs to be shortened.

The produced Phellinus linteus beverage is then cooled down to fill heat-resisting and airtight PET containers, resulting in the final Phellinus linteus beverage product. The Phellinus linteus beverage product of the present invention bottled in PET containers, thus, is handy to carry.

1. producing method of a Phellinus linteus beverage Adding 0.07 0.2 weight parts of Phellinus linteus into 100 weight parts of R/O water with 20 30 hardness;
Boiling the R/O water containing Phellinus linteus for a required time to obtain Phellinus linteus extract;
Filtering the Phellinus linteus extract;
Producing a Phellinus linteus beverage by mixing the Phellinus linteus extract and R/O water at fixed ratio; and
Sterilizing the beverage by UHT method at 121° C.-130° C. for 90 seconds.

2. A Phellinus linteus beverage produced by the method of claim 1.

3. A Phellinus linteus beverage product prepared by filling the Phellinus linteus beverage of claim 2 into heat-resisting airtight PET containers.
